(19) United States
(12) Patent Application Publication
(10) Pub. No.: US 2005/0172475 A1
(43) Pub. Date: Aug. 11, 2005

(54) Method of processing wooden material and processed piece of wood

(75) Inventor: Tatsuya Suzuki, Tokyo (JP)

Correspondence Address: HOGAN & HARTSON L.L.P., 500 S. GRAND AVENUE, SUITE 1900, LOS ANGELES, CA, 90071-2611, US

(73) Assignee: OLYMPUS CORPORATION

(21) Appl. No.: 11/061,172

(22) Filed: Feb. 18, 2005

Related U.S. Application Data
(63) Continuation of application No. PCT/JP05/00797, filed on Jan. 17, 2005.

(30) Foreign Application Priority Data
Jan. 20, 2004 (JP) P2004-011799

(51) Int. Cl. B25G 3/34

(52) U.S. Cl. 29/592

(57) ABSTRACT

A method of processing a wooden material by a molding die for three dimensional molding comprises cutting the wooden material to form a member to be compressed, providing the member with a curved surface corresponding to a surface of the molding die, and a convex portion or a concave portion which is projected or is recessed, respectively, with respect to the curved surface and on either surface of which a woodgrain is exposed, and compressing the member by the molding die.

### PRIORITY CLAIM

This application is a continuation application of a PCT Application No. PCT/JP2005/000797, filed Jan. 17, 2005, entitled “METHOD OF PROCESSING WOODEN MATERIAL AND PROCESSED PIECE OF WOOD”, whose priority is claimed on Japanese Patent Application No. 2004-11799, filed Jan. 20, 2004. The content of both the PCT Application and the Japanese Application is incorporated herein by reference.

### BACKGROUND OF THE INVENTION

1. Field of the Invention

The invention relates to a method of processing a wooden material and a piece of wood manufactured thereby, and particularly to a method of processing a wooden material that is highly ornamental and suitable as a covering member and a piece of wood manufactured thereby.

2. Description of Related Art

A covering member is used for a hand-held device such as a camera, a portable telephone, an IC recorder, a PDA, and a remote control for a household electric product, like a television, a video recorder, an air conditioner, and a projector. The covering member is mass produced industrially in consideration of not only functional aspects of formability, solidity and corrosion resistance but also design aspects of appearance and shape. Accordingly, it is common for the covering member to be made of a material suitable for mass production, such as a synthetic resin covering ABS, polycarbonate, and acryl, or a light metal covering aluminum, stainless steel, titanium, and magnesium.

Since a material such as a synthetic resin or a light metal is not hygroscopic, the material has the disadvantage that it is difficult to hold comfortably in the hand. In contrast, a natural material such as wood or bamboo is highly hygroscopic, and in addition is endowed with delicate features and is comfortable in the hand and provides good sensation. In particular, natural woodgrain, which is exposed on a surface, brings about superior visual effects to a unified industrial design.

Because of this, in order to make use of the features of a natural material and emphasize a design as an industrial product, a method of processing a wooden material has been proposed by which artificial ornamentation is added to woodgrain patterns.

For example, Japanese Patent Publication Hei 11-226915 (pages 2-4 and FIGS. 1-7) discloses a compressed cross grain flat wood having ornamental patterns and a manufacturing method therefor. According to the Publication, a concave portion or a convex portion is formed by cutting, from a reference plane on the surface of a flat wooden material and then by making the surface smooth through a pressing, altered woodgrain patterns are formed on a corresponding portion at each of the concave and convex portions.

### SUMMARY OF THE INVENTION

One aspect of the invention relates to a method of processing a wooden material by a molding die for three dimensional molding. The method comprises cutting the wooden material to form a member to be compressed; providing the member with a curved surface corresponding to a surface of the molding die, and a convex portion or a concave portion which is projected or is recessed, respectively, with respect to the curved surface and on either surface of which a woodgrain is exposed; and compressing the member by the molding die.

Preferably, the member to be compressed includes a partial concave or convex, on the back side of the convex portion or the concave portion, respectively, and in a region of almost overlapping the convex portion or the concave portion.

Advantageously, the molding die includes one die surface for compressing the convex portion or the concave portion that contains a partially flat surface or a gentle concavity or convexity compared with the convex portion or the concave portion, respectively, and the other die surface for compressing the back side of the convex portion or the concave portion is partially concave or convex, respectively, in a region of almost overlapping the convex portion or the concave portion.

Preferably, the convex portion or the concave portion is formed through being partially removed by a plane cutting, after a convex curved portion or a corner portion is formed on the member to be compressed.

Preferably, a piece of wood is processed by one of the methods of processing a wooden material described above.

### BRIEF DESCRIPTION OF THE DRAWINGS

FIG. 1 is a sectional view of a digital camera using as a covering member a piece of wood in a first application of the invention.

FIG. 2A is a plan view for explaining a structure of the covering member used in the digital camera of FIG. 1.

FIG. 2B is a sectional view taken along P-P of the plan view of FIG. 2A.

FIG. 2C is a sectional view taken along Q-Q of the plan view of FIG. 2A.

FIGS. 3A and 3B are a conceptual diagram for illustrating a method of processing a wooden material of an embodiment in accordance with the invention.

FIG. 4 is a partial sectional view for illustrating an original form of a wooden material before a wooden material of an embodiment in accordance with the invention is compressed

FIG. 5A is a conceptual figure for illustrating a convex portion of a wooden material to be processed by a method of processing a wooden material with respect to an embodiment in accordance with the invention.

FIG. 5B is a conceptual figure for illustrating a concave portion of a wooden material to be processed by a method of processing a wooden material with respect to an embodiment in accordance with the invention.

FIG. 6 is a conceptual figure for illustrating another concave portion in the same way.

FIG. 7A is a sectional view of a convex portion before compression for explaining one example of forming a woodgrain in a method of processing a wooden material with respect to an embodiment in accordance with the invention.

FIG. 7B is a plan view of a convex portion before compression for explaining one example of forming a woodgrain in the same method as that of FIG. 7A.

FIG. 7C is a sectional view of a convex portion after compression for explaining one example of forming a woodgrain in the same method as that of FIG. 7A.

FIG. 7D is a plan view of a convex portion after compression for explaining one example of forming a woodgrain in the same method as that of FIG. 7A.

FIG. 8A is a sectional view of a convex portion before compression for explaining another example of forming a woodgrain, as in FIG. 7A.

FIG. 8B is a plan view of a convex portion before compression for explaining another example of forming a woodgrain, as in FIG. 7B.

FIG. 8C is a sectional view of a convex portion after compression for explaining another example of forming a woodgrain, as in FIG. 7C.

FIG. 8D is a plan view of a convex portion after compression for explaining another example of forming a woodgrain, as in FIG. 7D.

FIG. 9A is a sectional view of still another example with a convex portion at the front and a partial concavity at the back of a wooden material before compression for forming a woodgrain, as in FIG. 7A.

FIG. 9B is a plan view of still another example with a convex portion at the front and a partial concavity at the back of a wooden material before compression for forming a woodgrain, as in FIG. 7B.

FIG. 9C is a sectional view of still another example with a convex portion at the front and a partial concavity at the back of a wooden material after compression for forming a woodgrain, as in FIG. 7C.

FIG. 9D is a plan view of still another example with a convex portion at the front and a partial concavity at the back of a wooden material after compression for forming a woodgrain, as in FIG. 7D.

FIG. 10A is an explanatory figure for showing a situation before compression of the wooden material shown in FIG. 9A.

FIG. 10B is an explanatory figure for showing a situation during compression of the wooden material shown in FIG. 9A.

FIG. 11A is an explanatory figure for showing a situation before compression in one variation of a method of processing a wooden material concerning an embodiment in accordance with the invention.

FIG. 11B is an explanatory figure for showing a situation during compression in one variation of a method of processing a wooden material concerning an embodiment in accordance with the invention.

FIG. 12 is a perspective view of a remote controller for a household electric product that uses a piece of wood as a covering member in a second application of the invention.

FIG. 13A is a perspective view of a portable telephone having a camera in open state, which uses a piece of wood as a covering member in a third application of the invention.

FIG. 13B is a perspective view of a portable telephone having a camera in folded state, which uses a piece of wood as a covering member in a third application of the invention.

### DETAILED DESCRIPTION OF THE INVENTION

Embodiments in accordance with the invention will be described referring to the figures. In all the figures, even if the embodiments are different, the same reference numerals are applied to the same or equivalent elements, and explanations which are the same in the embodiments are omitted.

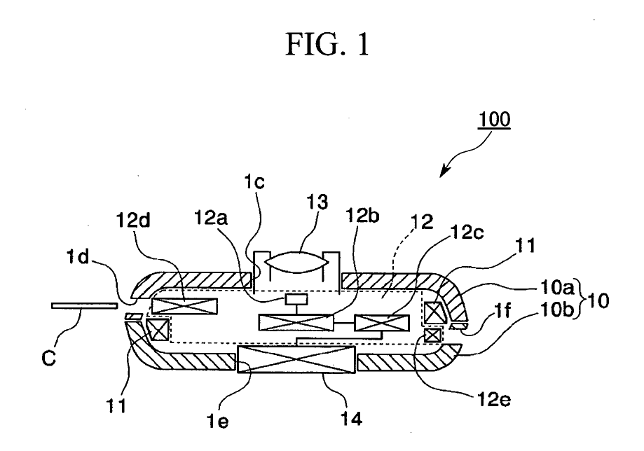

FIG. 1 is a sectional view of a digital camera using as a covering member a piece of wood concerning an embodiment of the invention.

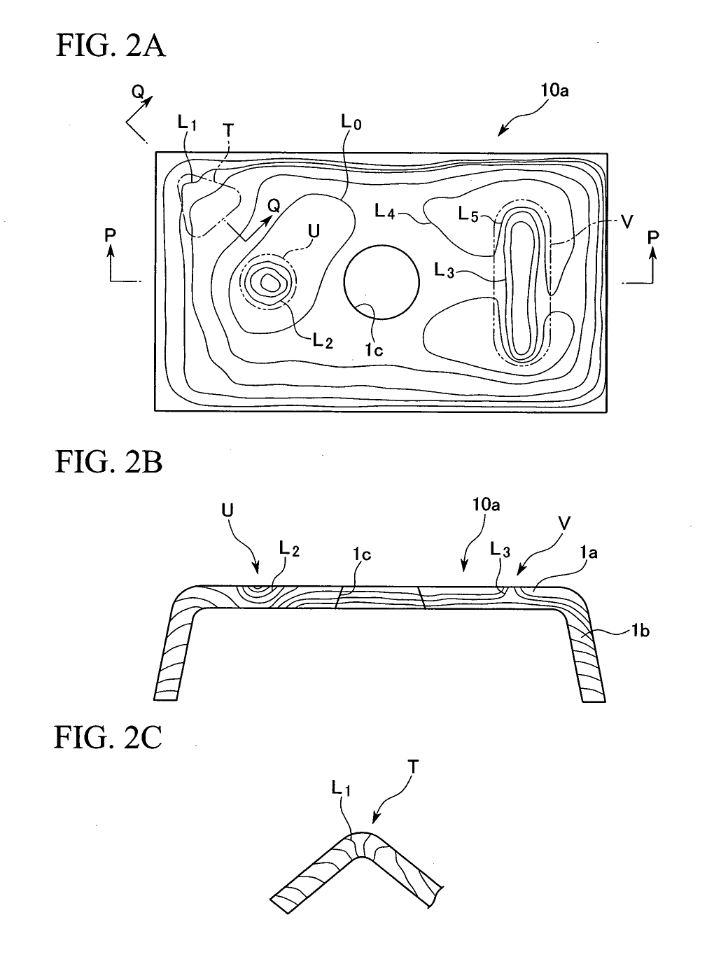

FIG. 2A is a plan view for explaining a structure of the covering member used in the digital camera of FIG. 1. FIG. 2B is a sectional view taken along P-P of the plan view of FIG. 2A. FIG. 2C is a sectional view taken along Q-Q of the plan view of FIG. 2A. In FIGS. 2A to 2C, a woodgrain is shown roughly. However, in FIG. 1, the woodgrain is omitted.

With respect to a processed piece of wood concerning an embodiment in accordance with the invention, a covering member 10 used in a digital camera 100 (an electronic device) shown in FIG. 1 is explained as one example.

The digital camera 100 includes a covering member (a processed piece of wood) 10, a frame 11, an internal mechanism 12, a taking lens 13, and a liquid crystal monitor 14 for displaying images in the field of view of the taking lens 13.

The covering member 10, comprising a front cover 10a (a processed piece of wood) and a rear cover 10b (a processed piece of wood) is a covering material in which the internal mechanism 12 is contained and from which the taking lens 13 and the liquid crystal monitor 14 are exposed to the outside.

The front cover 10a, as shown in FIGS. 1, 2A, and 2B, is of a square box shape having almost the same thickness. The front cover 10a is provided with a round hole 1c for exposing the taking lens 13 at the bottom portion, and a hole 1d for inserting an image recording medium C at one side portion.

The rear cover 10b, as with the front cover 10a, is of a square box shape having almost the same thickness. As shown in FIG. 1, the rear cover 10b is provided with a rectangular window 1e for exposing the liquid crystal monitor 14 at the bottom portion, and a hole 1f for inserting a cable to connect with an external personal computer at one side portion. The front cover 10a and the rear cover 10b contain holes (not shown) for exposing a release button and various kinds of operation buttons. The holes are provided with doors or caps or are formed for attachment when the need arises.

Since FIGS. 1 and 2 are schematic diagrams, the surfaces carrying the hole 1c and the window 1e in the covering member 10, for example, are drawn as planar. The surfaces may be planar, but, in the embodiment in accordance with the invention, are curved having a gentle curvature.

The front cover 10a and the rear cover 10b use a wooden material strengthened by compressing, on the outer surface of which a woodgrain pattern appears. That is, the woodgrain pattern is formed to emerge by the fact that the outer surface is made of a surface of the wooden material itself, that transparent or translucent painting or coating is applied to the wooden material, or that the wooden material is processed so that it has convexities and concavities on the surface thereof.

With respect to the woodgrain pattern, an explanation will be made taking the front cover 10a as an example.

The woodgrain pattern, as shown in FIG. 2A, contains a woodgrain, such as woodgrains L₀ and L₄, exposed naturally when the wooden material is cut. On the other hand, the front cover 10a of the embodiment in accordance with the invention includes a woodgrain, such as woodgrains L₁, L₂, L₃ and L₅, exposed artificially so that patterns different from the natural woodgrain can be drawn in regions T, U, and V.

The woodgrain L₁ is an example in which in the region T of the corner of the front cover 10a, a woodgrain outside of the region T deflects at a boundary of the regions to produce an artificially distorted curvature in the region T.

The woodgrain L₂ is an example in which in the circular region U, a pattern similar to a concentric annual ring is formed artificially. When such a partial annual ring is desired to be obtained from a natural wood, one has to take the shape from the wood in a limited area such as a section adjacent to a branching. Therefore, large amount of materials having the annual ring cannot be prepared.

The woodgrain L₃ is an example in which in the oval region V a woodgrain is formed to be almost parallel to a long axis of the oval.

The woodgrain L₅ is an example in which at the boundary of the region V a natural woodgrain L₄ is deflected to produce an unnatural curvature.

The internal mechanism 12 includes an image pickup device 12a such as a CCD, a driving circuit 12b for the image pickup device 12a, a driving circuit 12c for the liquid crystal monitor, an image recording device 12d for the image recording medium C, and a terminal 12e for connecting with an external personal computer.

The frame 11 is manufactured from, for example, metal or synthetic resin to be a holding member to hold the internal mechanism 12, the front cover 10a, and the rear cover 10b.

A method of processing a covering member 10 will be explained that is a piece of wood of the embodiment in accordance with the invention. Since the front cover 10a and the rear cover 10b are manufactured essentially in the same way, only the front cover 10a will be explained as an example hereinbelow.

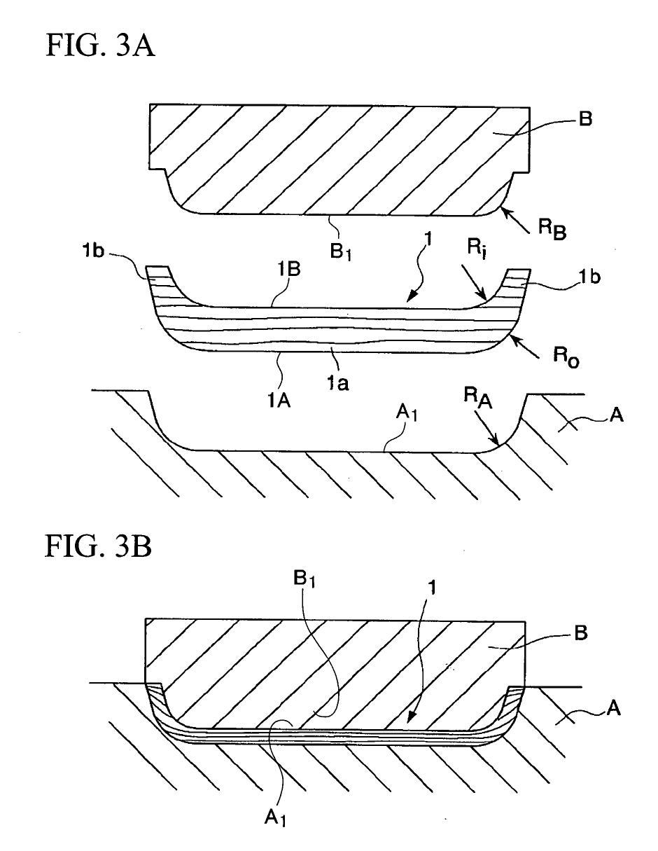

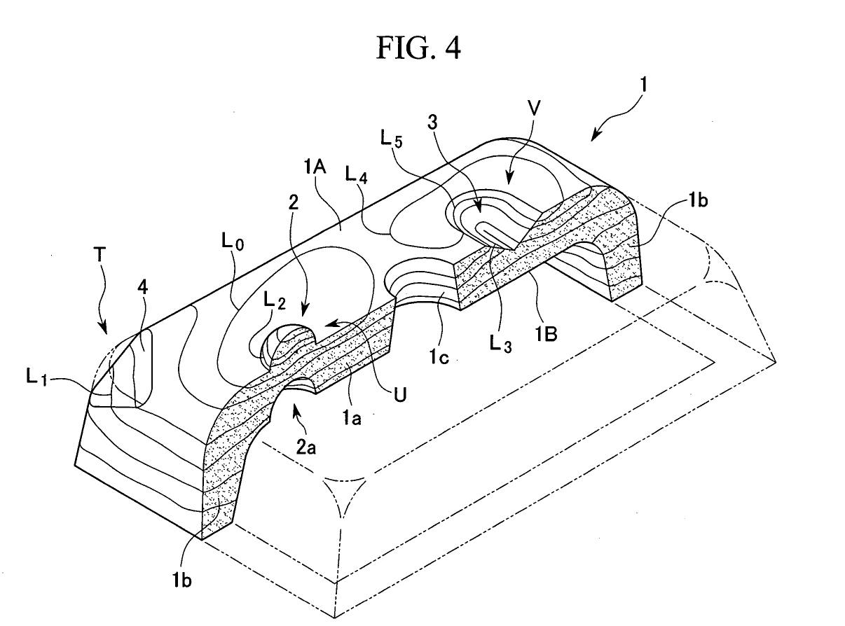

FIGS. 3A and 3B are a conceptual diagram for illustrating a method of processing the covering member 10. FIG. 4 is a partial sectional view for illustrating an original form of a wooden material before the covering member 10 is processed.

The front cover 10a, as shown in FIGS. 3A and 3B, is manufactured by compression molding an original wooden material 1 (a member to be compressed), using a lower form A (a molding die) made in a concave shape and a upper form B (a molding die) made in a convex shape. Notations A₁ and B₁ represent the die surfaces of the lower form A and the upper form B, respectively.

The shape of the front cover 10a, which includes a wall 1b in the circumference of a square bottom 1a, is box-shaped. The wooden material 1 prior to being compressed is chipped (cutting) from a block of raw wood, which connects the bottom 1a with the wall 1b in a gentle curvature. A woodgrain at the bottom 1a is in a length direction, while a woodgrain at the wall 1b is in a thickness direction of the wall 1b.

In the wooden material 1, hereinbelow, the surface to which the die surface A₁ is transferred is named an outer surface 1A, and the surface to which the die surface B₁ is transferred is named an outer surface 1B.

The relationship between the shape of the outer surface 1A of the wooden material 1 and the shape of the lower form A and the relationship between the shape of the inner surface 1B of the wooden material 1 and the shape of the upper form B will be discussed here.

As described above, the area from the bottom 1a to the wall 1b in the wooden material 1 is connected with a gentle curvature. When a radius of curvature of the curvature of the outer surface 1A is defined as R₀; a radius of curvature of the inner surface 1B on the backside of the above curvature of the outer surface 1A, Rᵢ; a radius of curvature of the curvature of the lower form A in contact with the curvature of the radius of curvature R₀ during compression, R_{A}; and a radius of curvature of the curvature of the upper form B in contact with the curvature of the radius of curvature Rᵢ during compression, R_{B}, the following relationship holds: R₀>R_{A} and Rᵢ>R_{B}. However, where a difference between the radii of curvature is too large, excessive bending stress is generated during compression to produce a break, which demands to maintain the difference at an allowable level. Accordingly, the outer surface 1A and the inner surface 1B is in the shape that approximately matches the shape of the lower form A and the upper form B, respectively.

Furthermore, the following can be selected as the wooden material 1: a Japanese cypress, a paulownia, a teak, a mahogany, a Japanese cedar, a pine, a cherry tree, a bamboo, or the like. In addition, not only the raw wood but also a woody material such as a compressed material that is made up of collected and solidified waste chips and sawdust can be used. In the latter case, instead of the woodgrain pattern, a pattern may be artificially formed by varying joints between different materials. In this case, continuity and regularity of the joints correspond to a natural woodgrain in the raw wood.

The details of the shape of the wooden material are shown in FIG. 4. In order to form an artificial woodgrain pattern after compression in the regions U, V, and T, a convex portion 2, a concave portion 3, and a plane cut portion 4 (a convex portion) are provided on the outer surface 1A. At the back side of the convex portion 2 and in a region almost overlapping the convex portion 2, a concave surface 2a (partial concavity) is formed. These convex and concave portions and the partial concavity are formed by cutting so as to make an artificial woodgrain appear on the surface.

A convex portion on the wooden material 1 is meant by a specified region left uncut when the other area is cut, in which, before compression, a convex portion having a limited area is formed whose curvature is clearly different from a curvature adjacent thereto, and after compression, that is cancelled to be smoothly connected to the curved surface adjacent thereto. In a similar way, a concave portion on the wooden material 1 is meant by a specified region formed by cutting that area.

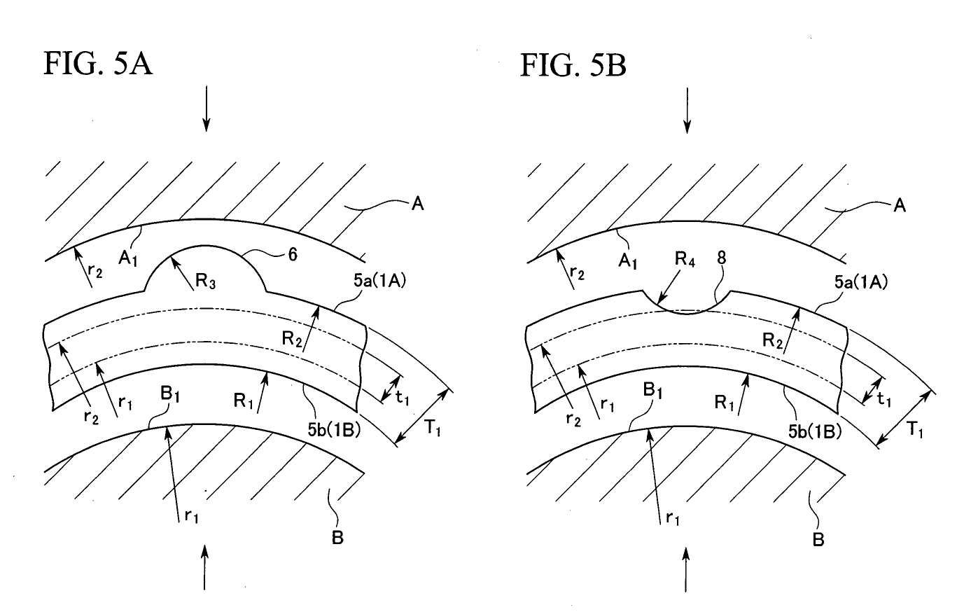

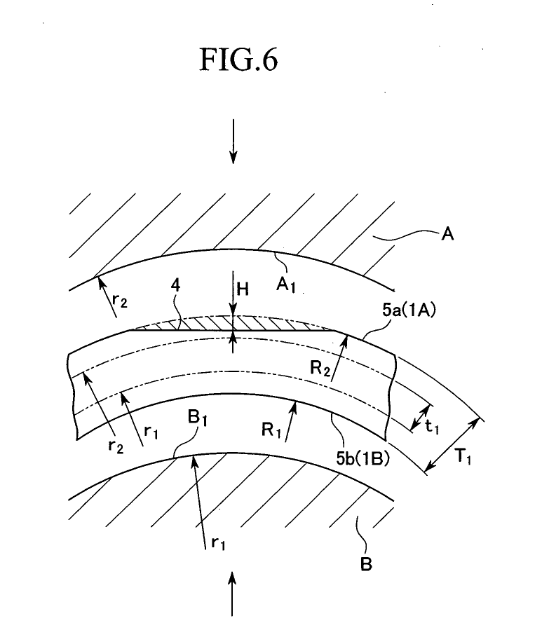

FIGS. 5A, 5B and 6 are conceptual figures for illustrating a convex portion and a concave portion of a wooden material 1.

For example, as in FIG. 5A, at a curved portion having a thickness T₁, a convex portion 6 having a radius of curvature R₃ (where R₃<R₂) is formed on a surface 5a of a radius of curvature R₂ composing a portion of the outer surface 1A. Under these circumstances, when the convex portion 6 is compressed by a die surface A₁ having a radius of curvature r₂ (where R₃<r₂<R₂) to have a thickness t₁, the portion corresponding to the convex portion 6 is shaped in the radius of curvature r₂ to cancel the convex portion 6.

As shown in FIG. 5B, instead of the convex portion 6, a concave portion 8 is made that has a concavity with a radius of curvature R₄ with respect to the surface 5a. In this case, when the concave portion 8 is compressed by the die surface A₁ having a radius of curvature r₂ to have a thickness t₁, the portion corresponding to the concave portion 8 is shaped in the radius of curvature r₂ to cancel the concave portion 8.

FIG. 6 is a conceptual figure in which, instead of the concave portion 8 in FIG. 5B, the surface 5a is removed (by cutting) by a maximum height H to produce the plane cut portion 4. In this case, the plane cut portion 4 constitutes a concavity of the wooden material 1. Since, in this case, a curved surface has only to be plane cut, there is the advantage that a concave portion can be easily made.

Next, the principle by which a woodgrain pattern is formed on the convex portion 6 is explained, taking a simple example.

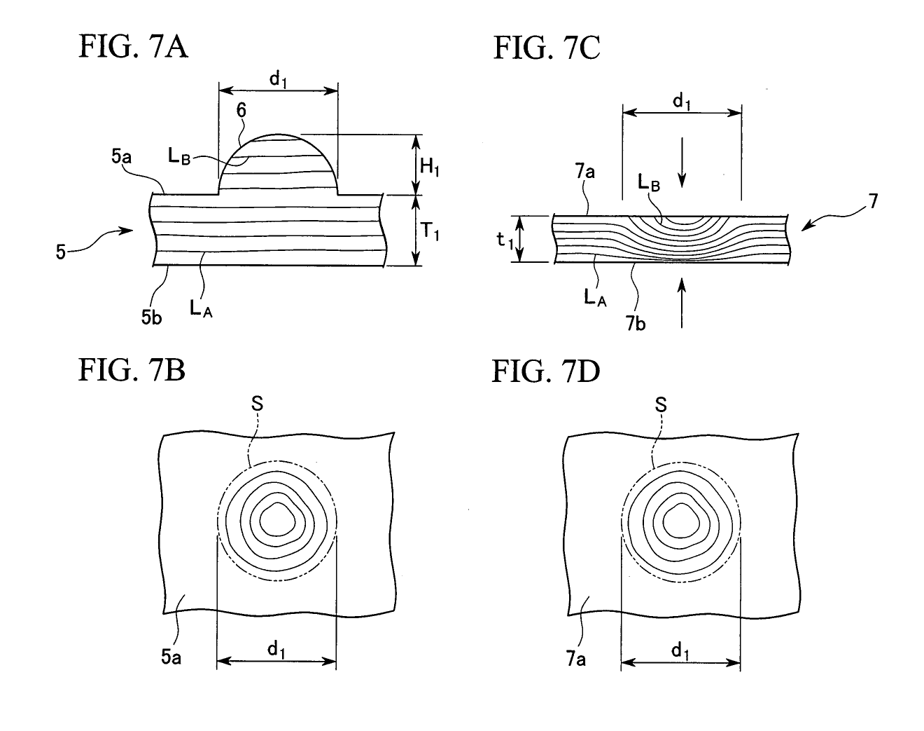

FIGS. 7A-7D are conceptual figures for illustrating one example of forming a woodgrain pattern in a method of processing a wooden material of the embodiment in accordance with the invention. FIG. 7A is a sectional view and FIG. 7B is a plan view, both prior to compression. FIG. 7C is a sectional view and FIG. 7D is a plan view, both after compression.

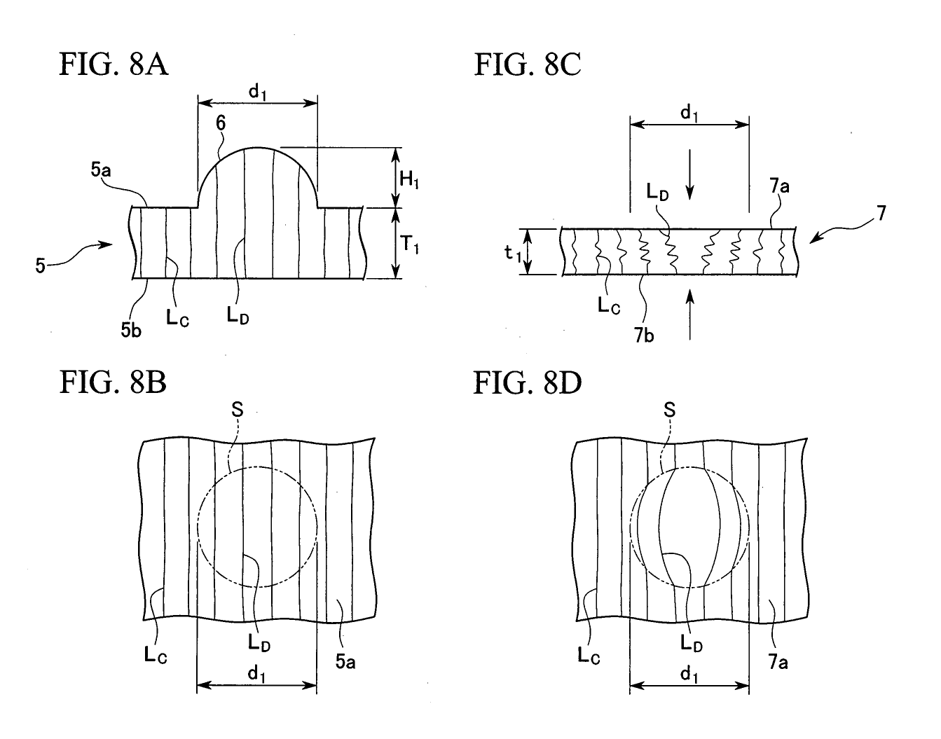

FIGS. 8A-8D are conceptual figures for illustrating another example of forming a woodgrain pattern. FIG. 8A is a sectional view and FIG. 8B is a plan view, both prior to compression. FIG. 8C is a sectional view and FIG. 8D is a plan view, both after compression.

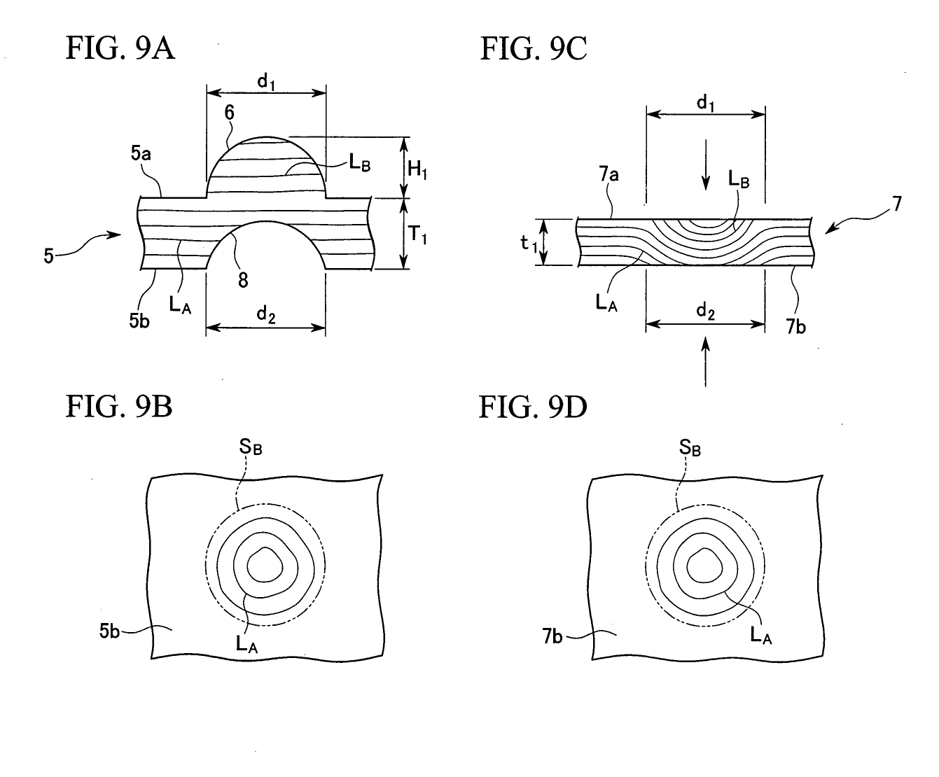

FIGS. 9A-9D is a conceptual figure for illustrating still another example of forming a woodgrain pattern. FIG. 9A is a sectional view and FIG. 9B is a rear view, both prior to compression. FIG. 9C is a sectional view and FIG. 9D is a rear view, both after compression.

Since a curvature of a tabular portion 5 is not essential in describing the principle, the tabular portion 5 is shown as flat in FIGS. 7A-9D.

Shown in FIGS. 7A-7D is an example in which a hemispheric convex portion 6 with a diameter d₁ and a height H₁ from the surface 5a is formed, when a woodgrain extends in an direction parallel to a surface of the tabular portion 5.

In FIGS. 7A and 7B, in the tabular portion 5 with a thickness T₁, there is a woodgrain L_{A} almost parallel to the surface 5a. On the surface of the convex portion 6, there is an exposed woodgrain L_{B} that is of concentric circles as viewed horizontally.

After compression, a compressed tabular portion 7 having a thickness t₁ is formed (see FIG. 7C). Then, the convex portion 6 is depressed into the compressed tabular portion 7, and the woodgrain L_{B} appears as a pattern having concentric circles in a region S on the surface 7a. In contrast, outside of the region S of the surface 7a, since the woodgrain L_{A} is not exposed, the surface remains plain. As a result, on the surface 7a after compression, a pattern having the concentric circles in the plain background is formed.

The region S has compression ratio C₂, and the vicinity thereof has compression ratio C₁=t₁/T₁. The maximum of C₂ is expressed as C₂=t₁/(H₁+T₁). Accordingly, since C₂<C₁, the region S receives higher compression to have high density.

According to the example shown in FIGS. 7A to 7D, the convex portion 6 is formed hemispherically. When, in place of the convex portion 6, a convex portion of a semicircular column whose cross section is semicircular is provided, a parallel line pattern is obtained instead of the concentric circles.

Shown in FIGS. 8A-8D is an example in which the convex portion 6 having a shape similar to that shown in FIGS. 7A-7D is formed, when a woodgrain extends in a direction of the thickness of the tabular portion 5.

In FIGS. 8A and 8B, inside of the tabular portion 5 of thickness T₁, there is a woodgrain L_{C} almost orthogonal to the surface 5a. On the surface of the convex portion 6, there is an exposed woodgrain L_{D} of parallel lines as viewed horizontally.

After compression, a compressed tabular portion 7 with a thickness t₁ is formed (see FIG. 8C). The convex portion 6 is depressed into the compressed tabular portion 7, and a woodgrain L_{D} is bent or forms an arc in the region S on the surface 7a, which disturbs the pattern of parallel lines in the vicinity. Because of this, bending of the woodgrain at a boundary of the region S visually emphasizes the inside of the region S.

Compression ratio of the region S is the same as that shown in FIGS. 7A-7D. In a direction of the thickness of the compressed tabular portion 7, the woodgrains L_{C} and L_{D} are folded in the shape of zigzag.

An example shown in FIGS. 9A-9D is a variation of that shown in FIGS. 7A-7D.

The example shows a concave portion 8 that is cut in the shape of a hemisphere in an area S_{B} with a diameter d₂, inside of the tabular portion 5 from the surface 5b and at the back side of the convex portion 6 (see FIG. 9A). In this case, on the side of the surface 5b, the woodgrain L_{A} exposed inside of the concave portion 8 appears in the shape of concentric circles (refer to FIG. 9B). After compression, on the surface 7b inside of the area S_{B}, a woodgrain pattern in the shape of concentric circles is formed. Moreover, it is apparent that a woodgrain pattern similar to that of FIG. 8D will appear on the surface 7b if a concave portion identical to the concave portion 8 is made on the surface 5b of FIG. 8A.

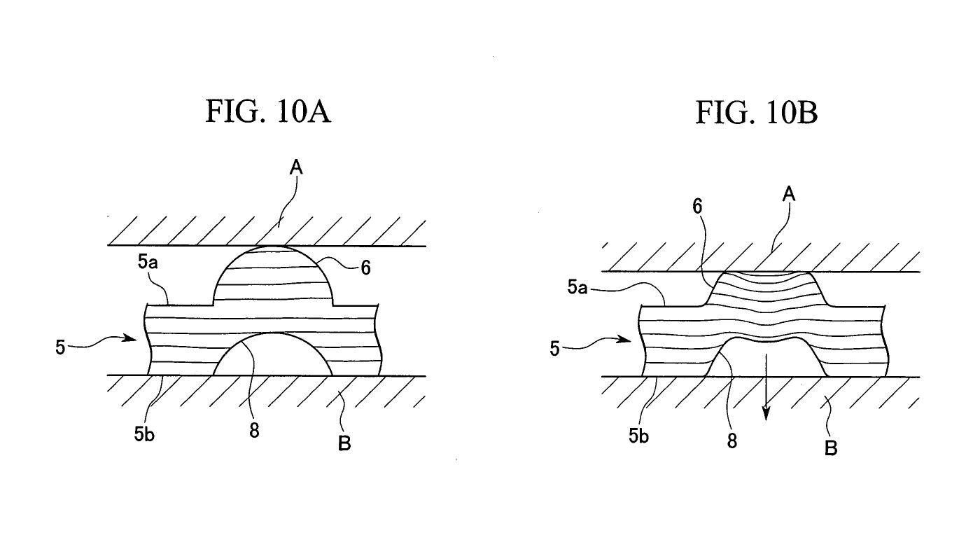

In this way, providing the appropriate sizes and shapes of the convex and concave portions with the front and back sides of the wooden material 1, respectively, and compressing the wooden material 1 can control a density thereof after compression. FIG. 10A shows a situation before compression, while FIG. 10B shows a situation during compression.

According to the example, there is the advantage that strength can be enhanced partially or made uniform partially depending on the needs even if the same die is used by changing the density of the compressed tabular portion 7 partially after compression, through appropriately combining a convex portion and a concave portion of the wooden material 1 according to the kind of the wooden material and the direction of the woodgrain.

For example, with respect to a covering material for an electronic device and in particular, a covering material for a hand-held device that is held in a hand while using it, in order to perform a function such as a hand held function, there are many cases in which a specified portion can be used as a grip portion having a complicated curve, or can have an attractive design. According to the embodiment, there is the advantage that the grip portion increases solidity and becomes a visually remarkable design so easily.

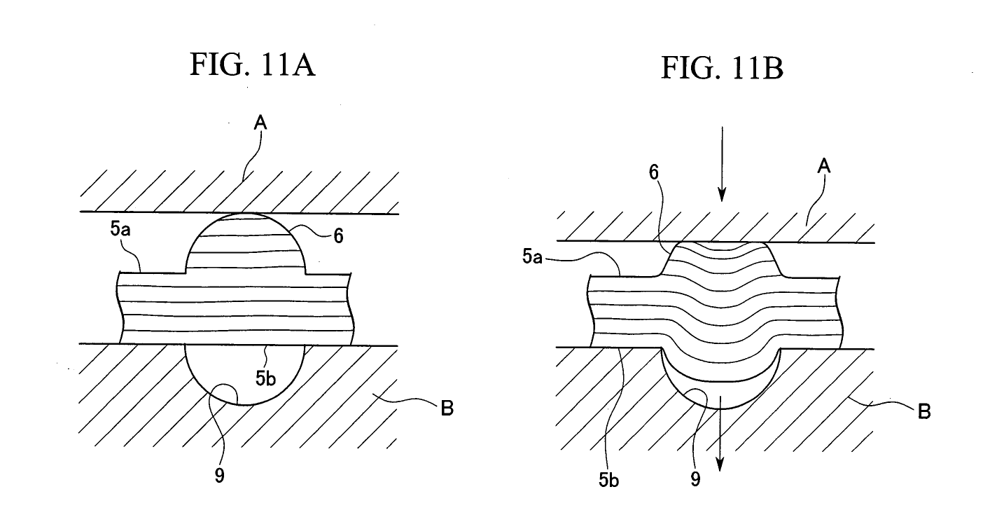

The density and strength of the woodgrain pattern can be also adjusted by forming a convex portion or a concave portion that escape or push the wooden material on the surface of the die. For example, as shown in FIG. 11A, a concave portion 9 is provided on the upper form B at the back side of the convex portion 6 set on the surface 5a. Under the circumstances, on compression the rear surface 5b escapes or moves to the inside of the concave portion 9 to form a convex shape, which makes a density smaller compared with the case in which the concave portion 9 is not present.

In this way, the ornamental woodgrain pattern formed by the embodiment is a mixture of the above simple patterns, depending on a direction of the woodgrain and a shape of each of the convex and concave portions, of the tabular portion 5. For example, the woodgrain L₂ in the area U of the front cover 10a (see FIGS. 2A and 2B) is formed in the same way as explained referring to FIG. 9. Likewise, for example, the woodgrain L₃ in the area V is made parallel by the concave portion 3 extended linearly. The woodgrain L₁ and L₅ is formed as a composite of the above simple cases.

It is easy to predict what woodgrain pattern will appear after compression if woodgrains exposed on the convex portions or concave portions are seen. When such woodgrain pattern does not satisfy the needs, the convex portions or concave portions can be further cut to make a fine adjustment.

Next, compression processes of the wooden material 1 will be explained.

First, the wooden material 1 is placed in a high temperature and high pressure atmosphere of water vapor, which makes the wooden material 1 absorb excessive moisture and become soft.

As shown in FIG. 3A, in the same high temperature and high pressure atmosphere of water vapor as is described above, the wooden material 1 is placed on the inner side of the lower form A.

As shown in FIG. 3B, the upper form B is moved to fit the inside of the lower form A, where the wooden material 1 is compressed between the upper form B and the lower form A, the state of which is maintained for a predetermined period of time. The wooden material 1 sandwiched by the upper form B and the lower form A has compressive force added at the bottom 1a and the wall 1b to be compressed to the thickness of about ½ to ⅓ of the original thickness. At this time, from the aforementioned relationship of the radius of curvature, no compressive force is applied to the wall 1b in the direction of the woodgrain, but an upward frictional force, which rubs upward the outer surface of the wall 1b, and a downward frictional force, which rubs downward the inner surface of the wall 1b, are applied to the wall 1b. Therefore, the woodgrain of the wall 1b, which was horizontal at first, is transformed as if it were bent vertically.

Finally, when the wooden material 1 is taken out from the lower and upper forms A and B after removing the high temperature and high pressure water vapor atmosphere, the wooden material 1 is molded in the shape of the internal space when the lower and upper forms A and B are fit. The bottom 1a and the wall 1b of the wooden material 1 have almost uniform thickness, respectively.

The wooden material 1 compressed and strengthened as described above includes finally the front cover 10a with a three dimensional shape having an artificial ornamental woodgrain pattern shown in FIG. 2, on the surface made smooth by a die. Therefore, since forming a woodgrain pattern and forming a three dimensional shape can be performed by one process, that is a method of processing a wooden material preferable for manufacturing a covering member for an electronic device or other industrial products, making the best use of a woodgrain or a feature of the appearance of a wooden material.

Such covering material 10 is provided with high strength entirely by increasing density through compression. In addition, since the woodgrain of the wall 1b is bent vertically to complement strength of the wall 1b, the strength of the wall 1b can be enhanced to the level that is the same as other portions, which gives sufficient strength to the covering material 10 without using a thick wooden material.

Because of this, mass production of the high quality digital camera 100 can be realized that has an excellent hygroscopicity and a delicate feature, and is comfortable in the hands and provides good sensation like a natural material such as wood or bamboo does.

The shapes of the convex portion and the concave portion in the above description are one example, and the invention is not limited to such shapes.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

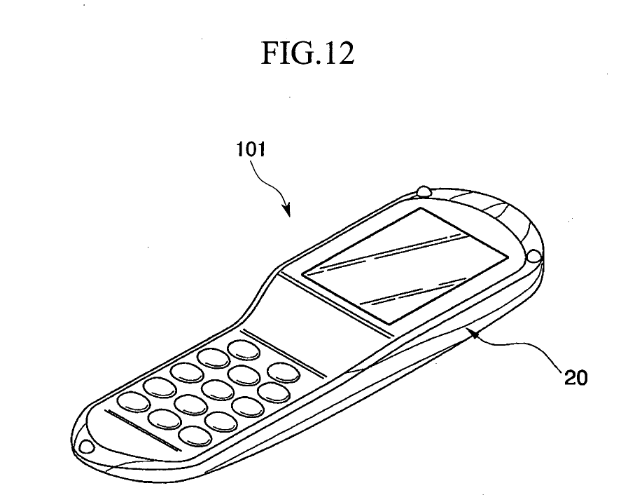

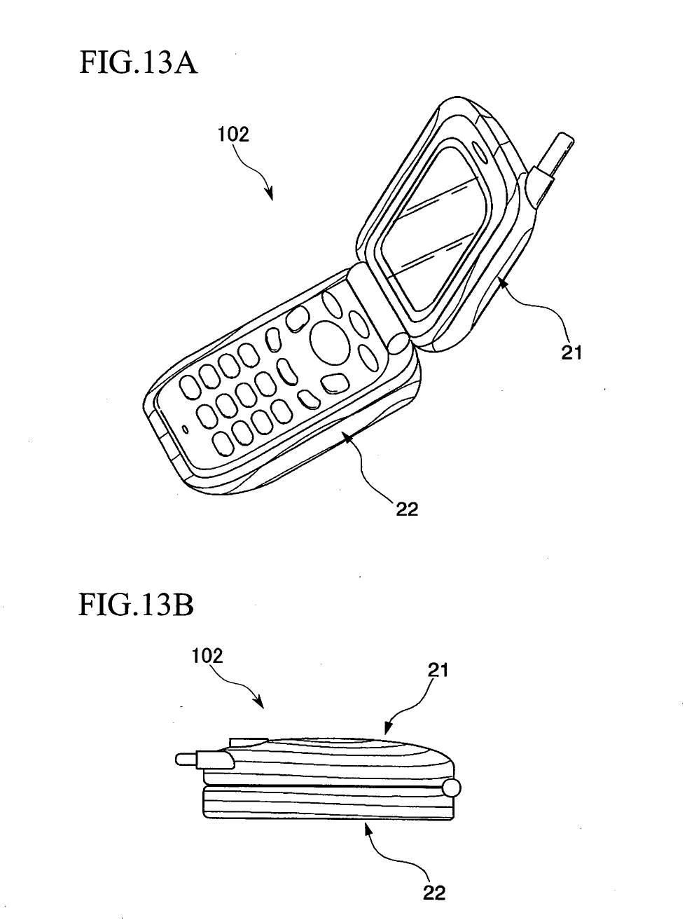

The embodiment explains a case, in which a processed piece of wood can be applicable to a digital camera as one example of an electronic device. The invention can be applied to the covering material 20 for the remote controller 101 used for household electric products (for example, a television, a video recorder, an air conditioner, and a projector) shown in FIG. 12, and to the covering material 21 and 22 for a portable telephone with a camera 102 shown in FIGS. 13A and 13B. Furthermore, the invention is preferable for hand held electronic devices such as an IC recorder and a PDA (not shown).

1. A method of processing a wooden material by a molding die for three dimensional molding, comprising:
cutting the wooden material to form a member to be compressed;
providing the member with a curved surface corresponding to a surface of the molding die, and a convex portion or a concave portion which is projected or is recessed, respectively, with respect to the curved surface and on either surface of which a woodgrain is exposed; and
compressing the member by the molding die.

2. A method of processing a wooden material as recited in claim 1, wherein the member to be compressed includes a partial concavity or convexity, on the back side of the convex portion or the concave portion, respectively, and in a region of almost overlapping the convex portion or the concave portion.

3. A method of processing a wooden material as recited in claim 1, wherein the molding die includes one die surface for compressing the convex portion or the concave portion that contains a partially flat surface or a gentle concavity or convexity compared with the convex portion or the concave portion, respectively, and the other die surface for compressing the back side of the convex portion or the concave portion is partially concave or convex, respectively, in a region of almost overlapping the convex portion or the concave portion.

4. A method of processing a wooden material as recited in claim 1, wherein the convex portion or the concave portion is formed through being partially removed by a plane cutting, after a convex curved portion or a corner portion is formed on the member to be compressed.

5. A piece of a wooden material processed by the method of processing a wooden material as recited in claim 1.
